(19) United States
(12) Patent Application Publication
(10) Pub. No.: US 2014/0270182 A1
(43) Pub. Date: Sep. 18, 2014

(54) Sound For Map Display

(71) Applicant: NOKIA CORPORATION, Espoo (FI)

(72) Inventors: Miikka T. Vilermo, Siuro (FI); Matti S. Hamalainen, Lempaala (FI); Roope Jarvinen, Lempaala (FI); Kimmo Roimela, Tampere (FI)

(73) Assignee: Nokia Corporation, Espoo (FI)

(21) Appl. No.: 13/827,394

(22) Filed: Mar. 14, 2013

(51) Int. Cl. H04S 7/00; H04S 5/00

(52) U.S. Cl. CPC H04S 7/303; H04S 5/005
USPC 381/17

(57) ABSTRACT

A method including associating a sound with a first location in a virtual three dimensional (3D) map; and during navigation of a user from a second location to the first location with use of the virtual 3D map, playing the sound by an apparatus based, at least partially, upon information from the virtual 3D map.

### BACKGROUND

1. Technical Field

The exemplary and non-limiting embodiments relate generally to sound and, more particularly, to playing of sound with display of a map.

2. Brief Description of Prior Developments

Three dimensional (3D) virtual maps have become popular. As an example, GOOGLE STREETVIEW or NOKIA's 3D CITY MAPS are known. These maps provide a rather realistic view to cities around the world. However, one element is missing: sound. There are many existing methods to create sounds to virtual environments like in the case of a game sound design. Yet, the combination of real cities and their virtual maps is rather new. Navigational prompts, such as a voice command during map navigation, are also known.

### SUMMARY

The following summary is merely intended to be exemplary. The summary is not intended to limit the scope of the claims.

In accordance with one aspect, an example method comprises associating a sound with a first location in a virtual three dimensional (3D) map; and during navigation of a user from a second location to the first location with use of the virtual 3D map, playing the sound by an apparatus based, at least partially, upon information from the virtual 3D map.

In accordance with another aspect, an example apparatus comprises a non-transitory program storage device readable by a machine, tangibly embodying a program of instructions executable by the machine for performing operations, the operations comprising associating a sound with a location in a virtual three dimensional (3D) map; and during navigation of a user from a second location to a first location with use of the virtual 3D map, playing the sound based, at least partially, upon information from the virtual 3D map.

In accordance with another aspect, an example embodiment is provided in apparatus comprising a processor and a memory comprising software configured to associate a sound with a location in a virtual three dimensional (3D) map; and during navigation of a user from a second location to a first location with use of the virtual 3D map, control playing of the sound based, at least partially, upon information from the virtual 3D map.

### BRIEF DESCRIPTION OF THE DRAWINGS

The foregoing aspects and other features are explained in the following description, taken in connection with the accompanying drawings, wherein:

FIG. 1 is a front view of an apparatus comprising features of an example embodiment;

FIG. 2 is a diagram illustrating some of the components of the apparatus shown in FIG. 1;

FIG. 3 is a diagram illustrating some of the components of the apparatus shown in FIG. 1;

FIG. 4 is a diagram illustrating an image and added features shown on the display of the apparatus shown in FIG. 1;

FIG. 5 is a diagram illustrating a map and a navigation path shown on the display of the apparatus shown in FIG. 1;

FIG. 6 is a graphical representation illustrating a graph used in the navigation application shown in FIG. 3 and relation to a user and sound sources;

FIG. 7 is a diagram illustrating an example method;

FIG. 8 is a diagram illustrating an example method;

FIG. 9 is a diagram illustrating an example method;

FIG. 10 is a graphical representation illustrating how features may be used with virtual world sound reflections.

### DETAILED DESCRIPTION OF EMBODIMENTS

Referring to FIG. 1, there is shown a front view of an apparatus 10 incorporating features of an example embodiment. Although the features will be described with reference to the example embodiments shown in the drawings, it should be understood that features can be embodied in many alternate forms of embodiments. In addition, any suitable size, shape or type of elements or materials could be used.

The apparatus 10 may be a hand-held communications device which includes a telephone application. The apparatus 10 may also comprise an Internet browser application, camera application, video recorder application, music player and recorder application, email application, navigation application, gaming application, and/or any other suitable electronic device application. Referring to both FIGS. 1 and 2, the apparatus 10, in this example embodiment, comprises a housing 12, a display 14, a receiver 16, a transmitter 18, a rechargeable battery 26, and a controller 20 which can include at least one processor 22, at least one memory 24 and software 26. However, all of these features are not necessary to implement the features described below.

The display 14 in this example may be a touch screen display which functions as both a display screen and as a user input. However, features described herein may be used in a display which does not have a touch, user input feature. The user interface may also include a keypad 28. However, the keypad might not be provided if a touch screen is provided. The electronic circuitry inside the housing 12 may comprise a printed wiring board (PWB) having components such as the controller 20 thereon. The circuitry may include a sound transducer 30 provided as a microphone and one or more sound transducers 32 provided as a speaker and earpiece.

The receiver (s) 16 and transmitter(s) 18 form a primary communications system to allow the apparatus 10 to communicate with a wireless telephone system, such as a mobile telephone base station for example, or any other suitable communications link such as a wireless router for example. Referring also to FIG. 3, the apparatus comprises a navigation application 30. This navigation application 30 may include some of the navigation application software as part of the software 26. This navigation application 30 includes Virtual Three Dimensional (3D) Map capability 32. The apparatus 10 also has a position system 34, such as GPS for example, to determine the location of the apparatus 10.

Referring also to FIG. 4, the virtual three dimensional (3D) map capability 32 allows the apparatus 10 to display an image 36 on the display 14 which corresponds to a pre-recorded photograph of a location. The navigation application may also be adapted to show added enhanced information on the display in combination with the image 36, such as names of locations and distances to the locations such as illustrated by icons 38. The locations may comprise, for example, restaurants, shopping locations, Points of Interest (POI), entertainment locations, etc. In an alternate example embodiment the image 36 might be a real-time image as viewed by a camera of the apparatus 10 such as with NOKIA HERE CITY LENS.

Referring also to FIG. 5, a two dimensional map image 40 is shown which may be displayed on the display 14 by the navigation application 30. The navigation application 30 can provide a user with a path 41 to travel from a first location 42 to a second location 44. Nodes 46 along the path 41 correspond to navigation tasks where a user needs to turn or perform another type of navigation task. In an alternate example, the navigation task may merely comprise a node along the path 41 where a three dimensional (3D) virtual view may be rendered, such as with, GOOGLE STREETVIEW or NOKIA's 3D CITY MAPS for example.

Features as described herein may be used for optimizing surround sound for 3D map environments, such as provided on the apparatus 10 for example. With 3D virtual maps, features may be used where the audio playback takes the effect of surrounding objects (including the directionality of sound sources) within the virtual scene so as to provide a more realistic virtual reality. All 3D virtual map navigations are based on a graph of paths that can be travelled. 3D virtual maps, such as GOOGLE STREETVIEW for example, have as their nodes the locations that have a 3D view of the surroundings available. Features as described herein may use graphs to simplify adding sounds to virtual worlds and using scanned 3D objects, such as buildings for example, to add reality to virtual worlds.

Adding sounds to virtual 3D maps can require a lot of processing power or sound very unnatural. Features as described herein may be used to reduce the necessary processing power, and also help to make the sound quality very natural (more realistic).

In one example embodiment, when sounds are spatialized to a user in a virtual environment, they are rendered to only the directions where the user can move, when the user is far away from the sound source. This makes navigation based on sounds easier for the user and requires less processing power than existing methods. In this case the objective is clearly not to create the sound scene for maximal authenticity. Instead, the objective is to play the sounds that are relevant from the navigation tasks point of view. Information that is typically present in such environment, but is not relevant for the navigation task, can be suppressed from the audio scene. The same sound may come from several directions, and the loudest direction may lead to the sound source the fastest.

Referring also to FIG. 6, a diagram is shown illustrating a user 50 of the apparatus 10 wearing headphones or earbuds 52 for sound from the apparatus 10. FIG. 6 illustrates a first location 54. The user 50 is located at a second location 56 (which has a node in this example). The navigation application may provide a navigation path 41′ from the second location 56 to the first location 54 for the user 50. In this example, the navigation path 41′ comprises three nodes 46a, 46b, 46c between the second location 56 where the user 50 is located and the first location 54. The navigation application 30 in this example is configured to associate a sound or sound source 58 with the desired destination of the user; the first location 54.

In this example, when the user 50 is at least one navigation node 46 away from the sound source 58 (the destination at the first location 54), then the sound source 58 is played from the navigation direction the user has to move to in order to get to the sound source 58. In this example, sound source 58″ and 58′ are merely the same sound as sound source 58, but at lower volumes. In this example:
the sound source 58″ is played as coming from the direction of the first node 46a when the user is at the starting location 56;
she sound source 58′ is then played as coming from the direction of the second node 46b when the user is at the first node 46a;
the sound source 58 is then played as coming from the direction of the third node 46c when the user is at the second node 46b.

This way, only as many directions as the user may move along the path 41′ needs to be rendered. This reduces complexity and, thus, reduces the necessary processing power and time for processing. Additionally, this reduces the possible sound sources in the same node as the user may need to be rendered. In an alternate example, the sound source 58 could be played from each node at the user approaches the node without changes in volume.

However, in some embodiments it may be desirable to play a sound source louder when the user is closer to the first location (the destination) than when the user is farther away from the first location (the destination). Stated another way, in some embodiments it may be desirable to play closer sources louder than sources further away. In one example embodiment, this type of volume difference may be achieved by applying a multiplier to the sound source each time one moves from one node to another node. The multiplier may depend on the length of the arc 47 between the nodes. In game audio design, game developers typically want to exaggerate audio cues. For example, sound attenuation may be much faster compared to the natural sound attenuation in an equivalent physical space. Therefore, the sound design may also be adapted to make the navigation task easier.

In one type of example, when a new source is added to a node N, the system may propagate its sound through the graph. For each neighboring node the sound may be added to the existing sounds coming from node N with a multiplier a, (0<a≦1) that depends on the graph arc length 47 between to graph nodes. Then, the sound is added to the neighbors of the neighbors of N, and so forth, until the sound is multiplied close to zero.

In the example shown in FIG. 6, the last node 46c may have a multiplier for 0.95 or 1.0 for example. The second to last node 46b may have a multiplier of 0.5 to provide a volume about ½ the volume of the sound source 58. The third to last node 46a may have a multiplier of 0.25 to provide a volume about ¼ the volume of the sound source 58. As the user travels along the path 41′ from node to node between 56 and 54, the volume of the sound source 58 gets louder. This is merely an example and should not be considered as limiting.

In one example embodiment, the sound sources are typically mono and have been recorded in an anechoic chamber. The sound sources are transmitted to the user as audio files (e.g. WAV, mp3 etc.). The sound sources are rendered to a user with headphones 52 using HRTF functions or, instead, loudspeakers can be used. “Auditory display” is a research field with a lot of literature on how to represent information to the user with audio. These systems can utilize 3D audio, but the content is commonly related to the graphical user interface (GUI) functionality.

Traditionally, sound sources in virtual worlds are rendered so that each source is rendered separately. For binaural playback each source is applied its corresponding head-related transfer function (HRTF) and the results are summed together. For multichannel playback each source is panned to the corresponding direction and loudspeaker signals are summed together. Panning or HRFT processing of sources individually requires a lot of processing power. In 3D maps, sounds such as verbal commands, are usually needed for directing the user to move in the right direction.

The sound played by the headphones 52 corresponding to a sound source (such as 58, 58′, 58″ for example) may be played to appear to come from a direction of the navigation path during playback. With a navigation application, there are usually a limited number of directions where the user can move (along a street for example). This can be used to limit the required processing power for directional sound generation. The sound sources 58, 58′, 58″ have an assigned location in the virtual world; at one of the nodes between the user and the final destination 54. A directed graph may be used for representing the map of the virtual world. A directed graph may be necessary because some streets may be one way and the sounds are different to different directions.

In one example embodiment, each arc 47 in the graph may have one sound associated to it called the arc sound. The arc sound may be the sum of the sounds that lead a user towards the sources of the summed sounds when one user traverses that arc. The arc sound may be played to a user from the direction of the arc (e.g. using HRTFs for example). Only those arc sounds where the arc leads away from the node where the user is, are played to the user. Each arc may have a weight called arc weight that is later used to attenuate the arc sounds relative to the length of the arc when a new sound source is added to the graph. The arc weight may be:

$$w ( a ) = {( \frac{1}{2} )}^{\frac{‖ a ‖}{100}}$$

where ∥a∥ refers to the length of the arc, such as in meters for example.

If the sound source is “close” to a user, or if the user can reach and touch it in the virtual world, or if the user can see the sound source (the user has a real world line-of-sight to the source), a sound source may be played from its actual direction instead of one of the directions where the user can move to. This is illustrated by location 54′ having sound source 59 shown in FIG. 6.

Each node in the graph may have one or more direct sounds. The direct sounds in a node are the sound sources that have a line-of-sight from their location to the node, and that are not too far away from the node. Thus, in one example, when the user is close to the sound source, the sound may be rendered from the actual direction of the sound source. In this way the user can best find the location of the sound source relatively quickly. Also, it should be possible for an administrator of the system to manually assign sound sources as direct sounds to a node. The system may calculate, for each direct sound in a node, a direction from which the sound should be played (i.e. the direction from the location of the sound source to the node). Also, each direct sound in a node may be assigned a weight proportional to the distance from the sound source location to the node. When a user is in a node, each of the direct sounds of that node may be played back to the user from the correct direction (e.g. using HRTFs for example). The apparatus 10 may be configured to allow a user to select and/or deselect which of the sounds should be played. Thus, in one type of example, even though the system may have 10 or more direct sound sources at a node, the user may be able to select only sound sources corresponding to a desired destination to be played, such as only sound sources corresponding to restaurants, or only sound sources corresponding to shopping locations. Thus, the sound sources actually played to the user may be reduced to only 1 or 2. The user may also be able to allow the user to chose and re-chose other selection criteria for playing the sound sources. For example, if in a first try the user only is provided with 2 choices within a first distance from the user, where the user does not like the 2 choices, the user may be able to reset the selection filter criteria to disregard choices in that first distance and extend the distance to a second farther distance from the user. This may give the user more choices and exclude the 2 closer choices which the user did not like.

Direct sounds may be attenuated with a weight that is dependent on the distance between the source location and the node. The attenuation weight may be for example:

$${( \frac{1}{2} )}^{\frac{distance}{100}} .$$

Instead of calculating the shortest path anew every time a new node is reached, the information of the direction that leads to the sound source and the loudness at which the sound should be played (essentially the distance to the sound source) could be stored relative to each node in order to reduce the complexity of the system. For more than one sound coming from the same direction, the sounds may be combined to reduce the number of sounds that need to be stored in a node. Combining sources that come to the user through the same arc in the graph is a novel feature which may be used.

Referring to FIG. 6, sound sources (such as 59) that have a line-of-sight to the user 50, and that are close enough, may be rendered from the actual direction of the sound sources using HRTFs. Sound sources (such as 58) that are further away from the user 50 are rendered from the direction of navigation (along the path 41′) that leads to the sound source.

In the example described above, the sound source (such as 59 in the example shown in FIG. 6) may be played back from the real direction of the sound source relative to the user 50 when:
the user is close to a sound source or an the same node as the sound source, or
when the user has a line of sight to a sound source close enough, or
if the user can reach and touch the sound source in the virtual world.

In one type of example embodiment, a sound source S may be added to the graph in the following manner:
An administrator (or a user) assigns a sound source to a location P. All the nodes xₗ, lε(l₁, l₂, . . . , l_{L}) that have a line-of-sight to the location, and that are not too far away from the location, are searched. In nodes xₗ the sound is added to the direct sounds of that node. Direct sounds are played back from the direction location P is from node xₗ. Let the direction be notated as D(P,xₗ) (later in this description, a simplified notation for directions is used). The directions are given as an angle to the direction of the sound source. The weight of the direct sound is:

$$w ( P , {x}_{l} ) = {( \frac{1}{2} )}^{\frac{‖ P - {x}_{l} ‖}{100}}$$

where ∥P−xₗ∥ denotes the distance between location P and node xₗ. From nodes xₗ the sound is then propagated to neighboring nodes using a pseudo code. The pseudo code stops when ail the nodes within hearing distance from the sound source have been processed. This is done by setting a minimum weight for the sounds. The minimum weight depends on how far the sounds are desired to be heard from. For example the minimum weight could be:

$${w}_{min} = {( \frac{1}{2} )}^{\frac{1000}{100}}$$

Each node can have a temporary weight (a positive real number) and a temporary flag (flagged/not flagged) assigned to it. In the beginning all nodes are assigned zero as weight and all nodes are unflagged. The process for the pseudo code may comprise:
Create an empty list Q.
Let the sound to be added be S.
Place ail the line-of-sight nodes xₗ to list Q, mark the temporary weight of the nodes xₗ as w(P, xₗ) and flag ail the nodes xₗ.
while the largest temporary weight of all nodes in Q is larger than the minimum weight:
   take the node X with the largest temporary weight V out of Q
   Find all the arcs w(aₖ), kε{k₁, k₂, . . . , k_{K}} leading to node X. For all kε{k₁, k₂, . . . , k_{K}}, multiply S with the weight of the node X and with the arc weight w(aₖ) and add the thus weighted S (i.e. w(aₖ)νS) to the existing arc sounds in arc aₖ.
   Find all the nodes mᵢ that have an arc at leading to X and that have been flagged. Set the temporary weight of all nodes mᵢ to the maximum of the current weight of mᵢ and the weight of X multiplied by the weight of arc aᵢ.
   Find all the nodes nⱼ that have an arc aⱼ leading to X and that have not been flagged. Set the temporary weight of all nodes nⱼ to the weight of X multiplied by the weight of arc aᵢ. Flag all nodes nⱼ and add them to Q.
end while.

Referring also to FIG. 7, the same pseudo code can be expressed in terms of a flowchart in a sound placement algorithm. This example flow chart comprises:
Block 100—Place sound S to location P
Block 102—Find all nodes xₗ with a line of sight to P
Block 104—Add sound S to the direct sounds of nodes xₗ, lε(l₁, l₂, . . . , l_{L}). The direction of sound S in node xₗ is D(P,xₗ)) and the weight is

$$w ( P , {x}_{l} ) = {( \frac{1}{2} )}^{\frac{‖ P - {x}_{l} ‖}{100}}$$

Block 106—Unflag all the nodes. Assign the temporary weight in each node to 0.
Block 108—Create an empty list Q
Block 110—Add nodes xₗ to Q, mark the temporary weight of the nodes xₗ as w(P,xₗ) and flag all the nodes xₗ
Block 112—while the largest temporary weight of all nodes in Q is larger than the minimum weight wₘᵢₙ
Block 114—take the node X with the largest temporary weight v out of Q
Block 116—Find all the arcs w(aₖ), kε{k₁, k₂, . . . , k_{K}}

leading to node x. For all kε{k₁, k₂, . . . , k_{K}}, multiply S with the weight of the node x and with the arc weight w(aₖ) and add the thus weighted S i.e. w(aₖ)νS to the existing arc sounds in arc aₖ.
Block 118—Find all the nodes mᵢ that have an arc aᵢ leading to X and that have been flagged. Set the temporary weight of all nodes mᵢ to the maximum of the current weight of mᵢ and the weight of x multiplied by the weight of arc aᵢ
Block 120—Find all the nodes nⱼ that have an arc aⱼ leading to x and that have not been flagged. Set the temporary weight of ail nodes nⱼ to the weight of x multiplied by the weight of arc aⱼ. Flag all nodes nⱼ and add them to Q.
   Please note that this is merely an example method.

The playback can be done for example as in the flowchart shown in FIG. 9 for playback of sounds using headphones. This example flow chart comprises:
Block 122—Run the sound placement algorithm separately for all the sounds that are added to the virtual world
Block 124—Find all the direct sounds DS₁, DS₂, . . . DSₚ in the node where the user is, and let D₁, D₂, . . . , Dₚ be the directions of these sounds.
Block 126—Find ail the arcs a₁, a₂, . . . , a_{R} chat lead away from the node where the use is. Find all arc sounds Sa₁, Sa₂, . . . Sa_{R} associated to these arcs and the directions of the arcs Da₁, Da₂, . . . , Da_{R}.
Block 128—Play back the found sounds to the user headphones. This is done by using the left and right HRTF functions with the right directions to each of the found sounds and summing together the results with the left and right headphone signals as shown in FIG. 8.

$$L = {\sum }_{p = 1}^{P} {HRTF}_{L} ( {DS}_{p} , {D}_{p} ) + {\sum }_{r = 1}^{R} {HRTF}_{L} ( {Sa}_{r} , {Da}_{r} )$$

$$R = {\sum }_{p = 1}^{P} {HRTF}_{R} ( {DS}_{p} , {D}_{p} ) + {\sum }_{r = 1}^{R} {HRTF}_{R} ( {Sa}_{r} , {Da}_{r} )$$

Please note that this is merely an example method. Rather than using headphones, the playback may be via speakers in a car for example, with an in-vehicle navigation system or a standalone GPS navigation device such as GARMIN, MAGELLAN, or TOMTOM coupled to speakers of a vehicle for example.

Summing the arc sounds together may lead to some inaccuracies. With an alternative embodiment it is possible to leave the arc sounds not summed. This way each arc may have several sounds associated to it. When the same sound reaches a node from several different directions (arcs), only the loudest one may be played back to the user.

In another aspect 3D scanning to get a rough estimate of the surrounding structures, and using images to recognize trees, lakes or snow may be used to refine the acoustic model may be used. When sounds are played back in a virtual world, the type of the surrounding area may be taken into account. Ambient environment sounds are very different in an open countryside setting, where there are almost no echoes, as compared to a narrow street with high-rise building on both sides where there are a lot of reflecting surfaces and hence echoes. Acoustic propagation of sound is a well understood phenomena and it can be modeled quite accurately provided that the model of the acoustic environment is accurate enough. However, accurate simulation of real physical spaces, such as a 3D city model for example, may require a lot of information about accurate geometries and acoustic properties of different surfaces. In mobile applications such level of fidelity is difficult to justify since the objective is to render a realistic illusion of a physical acoustic space instead of aiming for authentic rendering of sound environment, such as in the case of modeling of a concert hall for building such hall for example.

When 3D virtual city models are created, city buildings are 3D scanned. These 3D scans may also be used to control the rendering of audio. An impulse response that matches the current 3D scan may be applied to the sounds that are played, thus creating a better match between the visual and auditory percepts of the virtual world. When cities are photographed for making 3D models, creation of the base electronic navigable maps, such as NAVTEQ for example, also scans the buildings in 3D. The 3D model that is built of one cities can be used to help make audio sound more realistic. In a simple example implementation different filters may be applied to the audio signals depending on how many walls or other structures or objects are surrounding the node where the user is. For example there can be five different filters based on how many sides of the node are surrounded by walls (0-4).

In a first example, a database of 3D scans and related impulse responses are created. Different locations are 3D scanned (such as what NAVTEQ does). The scan results in a point cloud. Let the points of the point cloud in location X₁ be X_{1,1}, X_{1,2}, . . . X_{1,N1}. In the same locations, impulse responses from different directions to the user location are also recorded. For example directions with 10 degree spacing on the horizontal plane may be used. It is possible to use directions above or below the horizontal plane as well. Let the 36 directions on the horizontal plane be D₁, D₂, . . . , D₃₆. A starter pistol is fired around a microphone with an e.g. 5 meter radius from directions Dᵢ and the resulting sound is recorded. The recorded sounds are clipped to e.g. 20 ms. These are the recorded impulse responses from location X₁. Let's assume that the impulse responses are Iₓ_{₁}_{,1}, Iₓ_{₁}_{,2}, . . . , Iₓ_{₁}_{,36}. The impulse responses alongside with the point clouds are saved to a database. Finally, there are several locations x₁, x₂, . . . , x_{N} and their corresponding point clouds {x_{1,1}, x_{1,2}, . . . , x_{1,N}_{₁}}, {x_{2,1}, x_{2,2}, . . . x_{2,N}_{₂}}, . . . , {x_{N,1}, x_{N,2}, . . . , x_{N,N}_{_{N}}} and impulse responses {Iₓ_{₁}_{,1}, Iₓ_{₁}_{,2}, . . . Iₓ_{₁}_{,36}}, {Iₓ_{₂}_{,1}, Iₓ_{₂}_{,2}, . . . , Iₓ_{₂}_{,36}}, . . . , {Iₓ_{_{N}}_{,1}, Iₓ_{_{N}}_{,2}, . . . , Iₓ_{_{N}}_{,36}} in the database.

When a user is in the virtual world in location Y the point cloud scanned (by e.g. NAVTEQ) in location Y is compared to the point clouds in the database. Let she point cloud in location Y be {y₁, y₂, . . . , y_{M}}. Point clouds can be compared by comparing the points in them in the following way:

$$m = {argmin}_{i} ( {\sum }_{K = 1}^{M} {min}_{j} ‖ {x}_{i , j} - {y}_{k} ‖ )$$

Location Xₘ is now the location in the database that best corresponds to location Y. Therefore, the impulse responses {Iₓ_{ₘ}_{,1}, Iₓ_{ₘ}_{,2}, . . . , Iₓ_{ₘ}_{,36}} provide the most faithful audio rendering for added sound sources when the user is in location y in the virtual world. If a sound source is wanted to appear from direction D_{d} then the sound is first filtered with the impulse response Iₓ_{ₘ}_{,d} before it is rendered to the user using HRTFs (for headphone rendering) or VBAP for loudspeaker listening.

Playback of the Impulse response filtered sounds can be found in the following flowchart shown in FIG. 9 of playback of sounds for headphones. This example flow chart comprises:
Block 130—Run the sound placement algorithm separately for all the sounds that are added to the virtual world
Block 132—Find all the direct sounds DS₁, DS₂, . . . DSₚ in the node where one user is, and let D₁, D₂, . . . , Dₚ be the directions of these sounds.
Block 134—find ail the arcs a₁, a₂, . . . , a_{R} that lead away from the node where the use is. Find all arc sounds Sa₁, Sa₂, . . . Sa_{R} associated to these arcs and the directions of the arcs Da₁, Da₂, . . . , Da_{R}.
Block 136—Compare the point cloud of the node (location) the user is in to the point clouds in the database. Select the set of impulse responses {Iₓ_{ₘ}_{,1}, Iₓ_{ₘ}_{,2}, . . . , Iₓ_{ₘ}_{,3}} that are associated with the point cloud in the database that best matches the point cloud of the node where the user is.
Block 138—Let ƒ be a function that returns the impulse that is closest to direct D i.e.:

ƒ(D)=Iₓ_{ₘ}_{,i}|i=argminᵢ∥D−i*10°∥,i=1, . . . ,36
Block 140—Play back the found sounds to the user with headphones. This is done by using the left and right HRTF functions with the right directions to each of the found sounds and summing together the results. The left headphone signal is:

$$L = {\sum }_{p = 1}^{P} {HRTF}_{L} ( filter ( {DS}_{p} , f ( {D}_{p} ) ) , {D}_{p} ) + {\sum }_{r = 1}^{R} {HRTF}_{L} ( filter ( {Sa}_{r} , f ( {Da}_{r} ) ) , {Da}_{r} )$$

And the right headphone signal is:

$$L = {\sum }_{p = 1}^{P} {HRTF}_{R} ( filter ( {DS}_{p} , f ( {D}_{p} ) ) , {D}_{p} ) + {\sum }_{r = 1}^{R} {HRTF}_{R} ( filter ( {Sa}_{r} , f ( {Da}_{r} ) ) , {Da}_{r} )$$

Where HRTF_{L}(X,Y) is the HRTF function for a sound coming from direction Y to the left ear. And, “filter(x,y)” function filters sound x with impulse response y.
Please note that this is merely an example method.

In another example embodiment, instead of comparing different point clouds and having a database of impulse responses as in the first example embodiment described above, it is possible to estimate the desired impulse responses directly from the point cloud of the current location. Firstly, walls are detected from the point could of the current location. As an example (see FIG. 10) two walls 60, 62 have been detected in the scan. Reflections 64, 66 are added to sound sources when walls are detected. It should be noted that features as described herein may be used without regard to a navigation application. For example, a person sitting in an empty theatre listening to a playback of a prior performance in the theatre might be provided with different sounds based upon where in the theatre the person is sitting due to reflections. For example, a seat at a front right seat would have sound playback different versus if the person is sitting at a rear left seat of the theatre. Thus, features as described herein may apply to “reflections” and ancillary sound sources in a real world/virtual world hybrid system as described without regard to navigation per se.

An artificial sound source may be placed into the virtual world. The sound source could be e.g. directions to a Point Of Interest (POI), an advertisement, sound effects for an object in the virtual world like a fountain, etc. The sound source 59 played back to the user has reflections 64, 66 added to it to account for the expected sound environment from the visual environment. The sound from the sound source may be x. The total sound played to the user could be e.g.:

$$y ( t ) = f ( {L}_{1} ) * x ( t ) + f ( {L}_{2} ) * x ( t - \frac{{L}_{2}}{c} ) + f ( {L}_{3} ) * x ( t - \frac{{L}_{3}}{c} )$$

Where Lᵢ are the sound paths with reflections taken into account from the sound source to the user. ƒ(Lᵢ) is an attenuation function that attenuates sounds that travel a longer distance, ƒ(0)=1, ƒ(infinity)=0 where the scale is linear in decibel domain. Additionally each reflection can be made to have a frequency dependent additional attenuation. C is the speed of sound. Reflections are attenuated, delayed versions of the original sound source.

Filters may be created with several acoustic simulation methods, but even simple ray tracing model can produce a feel of sound envelopment that correlates with the 3D model of the reality and makes it easier to associate the sound scene with the reality. Similarly it is possible to map some environmental factors such as wind or rain into the sound scene, or traffic information such as congestion into the sound scene. In many cases Informative sound environment may be a much more preferable way of passing information about the environment compared to voice prompts telling that traffic is heavy or it is likely to rain.

A conventional 3D model itself does not describe the nature of sounds sources in the environment, but they can be created, or synthesized, based on the nearby POI information and sound libraries that correlate with the local geographical data such as, for example, a park in Tokyo surrounded by high buildings or a street in London next to a football stadium. Features as described herein may be independent of the sound sources, and sound creation methods that can be applied as a sound sources for such method. Also, the camera images of the surroundings can be used to affect the select ion of proper impulse responses. Recognition of trees/lakes/snow and other environmental structures may be mapped to the 3D model of environment to refine the acoustic model of the environment.

In one type of example, a method comprises associating a sound with a location in a virtual three dimensional (3D) map; and during navigation of a user to the location with use of the virtual 3D map, when a navigation task of the virtual 3D map is located between the user and the location, playing the sound as coming from a direction of the navigation task irrespective of a direct direction of the user relative to the location.

In one type of example embodiment, a non-transitory program storage device readable by a machine is provided, tangibly embodying a program of instructions executable by the machine for performing operations, the operations comprising associating a sound with a location in a virtual three dimensional (3D) map; and during navigation of a user to the location with use of the virtual 3D map, when a navigation task of the virtual 3D map is located between the user and the location, playing the sound as coming from a direction of the navigation task irrespective of a direct direction of the user relative to the location.

In one type of example embodiment, an apparatus comprises a processor and a memory comprising software configured to associate a sound with a location in a virtual three dimensional (3D) map; and during navigation of a user to the location with use of the virtual 3D map, when a navigation task of the virtual 3D map is located between the user and the location, play the sound as coming from a direction of the navigation task irrespective of a direct direction of the user relative to the location.

One type of example method comprises associating a sound with a first location in a virtual three dimensional (3D) map; and during navigation of a user from a second location to the first location with use of the virtual 3D map, playing the sound by an apparatus based, at least partially, upon information from the virtual 3D map.

When a navigation task of the virtual 3D map is located between the user and the first location, the method may comprise playing the sound as coming from a direction of the navigation task irrespective of a direct direction of the user relative to the first location. A volume of which the sound is played may be based, at least partially, upon a distance of a location of the navigation cask on the virtual 3D map relative to the first location. A volume of which the sound is played may be based, at least partially, upon at least one second navigation task of the virtual 3D map located between the user and the first location on the virtual 3D map. A volume of the sound may be based, at least partially, upon a distance of the user relative to the first location. When a navigation task of the virtual 3D map is not located between the user and the first location, the method may comprise playing the sound as coming from a direct direction of the first location relative to the user. Playing the sound may comprise playing the sound comprises playing the sound as coming from at least two directions. Playing the sound as coming from a first one of the directions may be played a first way, and where playing the sound as coming from a second one of the directions is played a second different way. The information from the virtual 3D map may comprise at least one of an ancillary sound source and a sound reflection source which influences playing of the sound.

In one type of example embodiment, a non-transitory program storage device readable by a machine is provided, tangibly embodying a program of Instructions executable by the machine for performing operations, the operations comprising associating a sound with a location in a virtual three dimensional (3D) map; and during navigation of a user from a second location to the first location with use of the virtual 3D map, playing the sound based, at least partially, upon information from the virtual 3D map. When a navigation task of the virtual 3D map is located between the user and the first location, the operations may comprise playing the sound as coming from a direction of the navigation task irrespective of a direct direction of the user relative to the first location. The Information from the virtual 3D map may comprise at least one of an ancillary sound source and a sound reflection source which influences playing of the sound.

In one type of example embodiment, an apparatus is provided comprising a processor and a memory comprising software configured to associate a sound with a location in a virtual three dimensional (3D) map; and during navigation of a user from a second location to a first location with use of the virtual 3D map, control playing of the sound based, at least partially, upon information from the virtual 3D map.

When a navigation task of the virtual 3D map is located between the user and the first location, the apparatus may be configured to control playing of the sound as coming from a direction of the navigation task irrespective of a direct direction of the user relative to the first location. The apparatus may be configured to control volume of which the sound is played is based, at least partially, upon a distance of a location of the navigation task on the virtual 3D map relative to the first location. The apparatus may be configured to control volume of which the sound is played is based, at least partially, upon at least one second navigation task of the virtual 3D map located between the user and the first location on the virtual 3D map. The apparatus may be configured to control volume of the sound based, at least partially, upon a distance of the user relative to the first location. When a navigation task of the virtual 3D map is not located between the user and the first location, the apparatus may be configured to control playing the sound as coming from a direct direction of the first location relative to the user. The apparatus may be configured to control playing the sound as coming from at least two directions. The Information from the virtual 3D map may comprise at least one of an ancillary sound source and a sound reflection source which influences playing of the sound. The apparatus may comprise means for controlling of playing of the sound based, at least partially, upon the information from the virtual 3D map.

In one type of example embodiment, an apparatus comprises a processor and a memory comprising software configured to associate a sound with a location in a virtual three dimensional (3D) map; and control playing of the sound based, at least partially, upon information from the virtual 3D map, the information from the virtual 3D map comprises at least one of an ancillary sound source and a sound reflection source which influences playing of the sound.

Unlike a video game where a character in the video game moves around the virtual world and the user hears different sounds as the character moves to different locations, features as described herein may be used where “a user” (in the real world) moves from a second location to a first location with use of the virtual 3D map. In one type of alternate example, the apparatus may be configured to control playing of the sound based upon some parameter in the virtual 3D map other than location of the user, such as the nearest node on the map (regardless of the actual position of the user) relative to the first position. For example, referring to FIG. 6, features may be used for a the situation of the user being 1 meter away from the node 46a and the situation of the user being 20 meters away from the node. A device could be provided where the device might not care where the second location is; it might merely care where the nearest node 46a is.

In one example embodiment, an apparatus is provided comprising a processor and a memory comprising software configured to: associate a sound with a location in a virtual three dimensional (3D) map; and during navigation from a second location to a first location within the virtual 3D map, control playing of the sound based, at least partially, upon the first location information within the virtual 3D map relative to the second location. The sound may be played based on the location of the first location relative to the second location.

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. A method comprising:
associating a sound with a first location in a virtual three dimensional (3D) map; and
during navigation of a user from a second location to the first location with use of the virtual 3D map, playing the sound by an apparatus based, at least partially, upon information from the virtual 3D map.

2. A method as in claim 1 where, when a navigation task of the virtual 3D map is located between the user and the first location, playing the sound as coming from a direction of the navigation task irrespective of a direct direction of the user relative to the first location.

3. A method as in claim 2 where a volume of which the sound is played is based, at least partially, upon a distance of a location of the navigation task on the virtual 3D map relative to the first location.

4. A method as in claim 2 where a volume of which the sound is played is based, at least partially, upon at least one second navigation task of the virtual 3D map located between the user and the first location on the virtual 3D map.

5. A method as in claim 1 where a volume of the sound is based, at least partially, upon a distance of the user relative to the first location.

6. A method as in claim 1 where, when a navigation task of the virtual 3D map is not located between the user and the first location, playing the sound as coming from a direct direction of the first location relative to the user.

7. A method as in claim 1 where playing the sound comprises playing the sound comprises playing the sound as coming from at least two directions.

8. A method as in claim 7 where playing the sound as coming from a first one of the directions is played a first way, and where playing the sound as coming from a second one of the directions is played a second different way.

9. A method as in claim 1 where the information from the virtual 3D map comprises at least one of an ancillary sound source and a sound reflection source which influences playing of the sound.

10. An apparatus comprising a processor and a memory comprising software configured to:
associate a sound with a location in a virtual three dimensional (3D) map; and
during navigation of a user from a second location to a first location with use of the virtual 3D map, control playing of the sound based, at least partially, upon information from the virtual 3D map.

11. An apparatus as claimed in claim 10 where, when a navigation task of the virtual 3D map is located between the user and the first location, the apparatus is configured to control playing of the sound as coming from a direction of the navigation task irrespective of a direct direction of the user relative to the first location.

12. An apparatus as claimed in claim 11 where the apparatus is configured to control volume of which the sound is played is based, at least partially, upon a distance of a location of the navigation task on the virtual 3D map relative to the first location.

13. An apparatus as claimed in claim 11 where the apparatus is configured to control volume of which the sound is played is based, at least partially, upon at least one second navigation task of the virtual 3D map located between the user and the first location on the virtual 3D map.

14. An apparatus as claimed in claim 10 where the apparatus is configured to control volume of the sound based, at least partially, upon a distance of the user relative to the first location.

15. An apparatus as claimed in claim 10 where, when a navigation task of the virtual 3D map is not located between the user and the first location, the apparatus is configured to control playing the sound as coming from a direct direction of the first location relative to the user.

16. An apparatus as claimed in claim 10 where the apparatus comprises means for controlling of playing of the sound based, at least partially, upon the information from the virtual 3D map.

17. An apparatus as claimed in claim 10 where the information from the virtual 3D map comprises at least one of an ancillary sound source and a sound reflection source which influences playing of the sound.

18. An apparatus as claimed in claim 10 where the memory forms a non-transitory program storage device, tangibly embodying a program of instructions executable for performing operations, the operations comprising:
associating the sound with the location in the virtual three dimensional (3D) map; and
during navigation of the user from the second location to the first location with use of the virtual 3D map, playing the sound based, at least partially, upon the Information from the virtual 3D map.

19. An apparatus as claimed in claim 18 where the operations comprise, when a navigation task of the virtual 3D map is located between the user and the first location, playing the sound as coming from a direction of the navigation task irrespective of a direct direction of the user relative to the first location

20. An apparatus comprising a processor and a memory comprising software configured to:
associate a sound with a location in a virtual three dimensional (3D) map; and
control playing of the sound based, at least partially, upon information from the virtual 3D map, the information from the virtual 3D map comprises at least one of an ancillary sound source and a sound reflection source which influences playing of the sound.
